(19) United States
(12) Patent Application Publication
(10) Pub. No.: US 2013/0106833 A1
(43) Pub. Date: May 2, 2013

(54) METHOD AND APPARATUS FOR OPTICAL TRACKING OF 3D POSE USING COMPLEX MARKERS

(71) Applicant: WEY FUN, SINGAPORE (SG)

(72) Inventor: WEY FUN, SINGAPORE (SG)

(21) Appl. No.: 13/286,128

(22) Filed: Oct. 31, 2011

(51) Int. Cl. G06T 15/00

(52) U.S. Cl. 345/419

(57) ABSTRACT

There is disclosed an input device for providing three-dimensional, six-degrees-of-freedom data input to a computer. in an embodiment the device includes a tracker having tracking points. One array of tracking points defines a first axis. Another array defines a second axis or plane orthogonal to the first axis. There is provided at least one cluster of tracking points. Selected distances are provided between the tracking points. This allows a processor to determine position and orientation of the input device in three-dimensional space based on a perspective, two-dimensional image of tracking points captured by a camera. In an embodiment, there is provided a method of providing three-dimensional, six-degrees-of-freedom data input to a computer. The method includes capturing an image of the tracker. Next, processing the image to determine distances between tracking points. Finally, determining position and orientation of the device using the distances determined. Other embodiments are also disclosed.

### FIELD OF THE INVENTION

The present invention relates to the computerized optical measurement of the position and orientation of the objects in three-dimensional (3D) space.

### BACKGROUND

In recent years optical tracking has become a popular tool in various applications that require knowledge of the poses of objects in three-dimensional (3D) space. A plethora of products are available serving various consumer, medical, industrial and military markets. Most of these products use stereoscopic sensors that use at least two cameras coupled with either stereovision-based, or triangulation-based, computations that extract the 3D (i.e., x,y,z) positions of markers arranged in predefined clusters. These markers may be active, retro-reflective or fully passive. The image sensors are monochrome and, thus, the image processing is simplified gray-scale methods.

The first-generation of commercialized optical tracking technology are those whose markers are spherical or circular in shape, where their image may be captured by cameras with no local feature. These ‘simple’ markers have the advantage of only requiring simple and fast computations to extract the positions of their centers from the brightness of pixels spanned by their images. However, these systems do have numerous disadvantages. First, these systems are costly to produce, and hard to mount accurately onto the tracked object. Second, their positions may not be accurately registered optically when partially obscured, or if their surfaces are covered by dust such that the captured image is not uniformly bright.

In contrast to the simple marker, the ‘complex’ marker is a more complex shape defined by a feature-rich boundary. Such a boundary is usually made up of multiple high-contrast edges, and the extraction of information related to the orientation and length of these edges in the 2D image itself contributes to the eventual 3D re-construction of the tracked object's pose. Furthermore, the corners where the edges meet are strong local features providing substantial information for the eventual 3D re-construction. The complex markers also allow better noise-rejection and, hence, make the technology more robust. The use of such complex markers was previously hampered by the high demand for computational resources and the need for costly high-resolution cameras, making them costly and unsuitable for real-time optical tracking. However, with the recent advancement of computing technology, increasing affordability of high-resolution cameras, faster connection means, and maturing sub-pixel edge detection algorithms, the use of complex markers is becoming more feasible.

In U.S. Pat. No. 6,978,167 (issued to Dekel, et al.), there is provided a method of optical tracking with the use of complex markers. The markers are composed of high-contrast regions arranged in alternating black and white areas with sharp crisp edges, and the corners of the regions coinciding the centers of interest. Dekel uses linear regression technique to precisely locate the edges of these regions with sub-pixel accuracy, and then locate the intersection of these edges and, hence, determine the centers-of-interest.

However, these marker designs have numerous problems. First, the black-white high-contrast regions must cross at the center, or centerline, of the marker. This implies that the length of each high-contrast edge is only half of the whole effective width of the marker. This causes inefficient use of precious spacing on the tracker, and the marker has to be of relatively large size in order for its image to span sufficient pixels on the overall picture to provide the desired accuracy in the re-construction. The mounting of these large markers on the target makes it non-ergonomic, and it interferes with the handling of the target. Second, the markers have large rounded corners, and the need to use special image processing techniques to handle the curve edges makes it less desirable than if only the processing of straight edges are involved. Third, since the markers' pattern spreads across a large area of the cluster, the image processing needs to scan a large area of the 2D image around the previously detected area of the cluster in order to extract the centers-of-interest. Fourth, it is not cost-effective to implement such complex algorithm in the onboard processor such as a flexible programmable gate array (FPGA) in the camera for real-time processing.

Furthermore, Dekel is based on the use of a stereoscopic sensor with at least two cameras. It is known that the stereoscopic sensor has numerous shortcomings as compared to a single-camera tracking system. First, the frame rate is slower and time lag is longer as the system needs to download the images from two cameras, and process both images, before attempting to match the markers' positions in the two images. In comparison, the single-camera system only needs to download and process a single image. Its demand on the computing resources is thus less than half of those multi-camera systems. Second, it is less accurate because of the additive errors caused by the imperfect optics from both lenses. Another source of inaccuracy is due to the fact that the two cameras could never be perfectly synchronized in their image captures, and if the tracked object is moving then the two images would reflect the object at different 3D positions. Beside these issues, dual-camera systems have obvious problems with higher cost and larger size.

In U.S. Pat. No. 7,768,498 (issued to Fun Wey, and hereinafter referred to as the Fun Wey '498 patent), the system is able to perform 3D, 6-degrees-of-freedom (6-DOF) tracking of objects with using only a single camera, extensible to multiple cameras. However, the Fun Wey '498 patent is still based on determining the centers of simple markers, and thus it suffers the shortcomings of difficulty in accurately locating the 2D positions of the markers in the image. In order to allow for applications requiring high-precision tracking, it is vital to introduce some new types of complex markers that may be more precisely registered in images.

Furthermore, the Fun Wey '498 patent uses an orientation marker to differentiate between two distinct 3D poses that otherwise produce similar 2D image. To precisely shield the orientation marker, such presence or absence of its image near the threshold, is difficult to achieve in practice. Moreover, the protruding shield could obscure some of the other markers and, thus, reduces the operating envelope of the device. With the ability to precisely determine markers' positions using complex markers, there would be no longer the need for the use of orientation marker and yet able to precisely track the object in any pose.

### SUMMARY

This summary is provided to introduce a selection of concepts in a simplified form that are further described below in the Detailed Description. This summary is not intended to identify key aspects or essential aspects of the claimed subject matter. Moreover, this Summary is not intended for use as an aid in determining the scope of the claimed subject matter.

In an embodiment, there is provided an input device for providing three-dimensional, six-degrees-of-freedom data input to a computer, said device comprising a tracker having a plurality of tracking points, the tracker including a first array of the tracking points defining a first axis; a second array of the tracking points defining one of a second axis and plane orthogonal to the first axis; and at least one cluster of the tracking points of one of the first array and the second array; selected distances between the tracking points disposed with respect to one another so as to allow a processor to determine position and orientation of the input device in three-dimensional space based on a perspective, two-dimensional image of the tracking points captured by at least one image-capturing device.

In another embodiment, there is provided a marker having a shape formed by a plurality of straight edges, and wherein the plurality of the tracking points are formed by intersections of the straight edges of the marker.

In yet another embodiment, there is provided method of providing three-dimensional, six-degrees-of-freedom data input to a computer, the method comprising capturing a perspective, two-dimensional image of a plurality of tracking points of a tracker; processing the perspective, two-dimensional image of the plurality of tracking points of the tracker to determine distances between the tracking points disposed with respect to one another; and determining position and orientation of the input device in three-dimensional space using the distances determined between the tracking points in comparison to known distances between the tracking points disposed with respect to one another.

In still another embodiment, there is provided a method of providing three-dimensional, six-degrees-of-freedom data input to a computer, the method comprising capturing a perspective, two-dimensional image of a plurality of tracking points of a tracker; processing the perspective, two-dimensional image of the plurality of tracking points of the tracker to determine distances between the tracking points disposed with respect to one another; and determining position and orientation of the input device in three-dimensional space using the distances determined between the tracking points in comparison to known distances between the tracking points disposed with respect to one another.

In another embodiment, there is provided a method further including determining spans between centers of the markers of along two axes, including a first axis of a first array of the tracking points and a second axis of a second array of tracking points, and further determining the orientation of the tracker by inter-axis resolution of the spans of the axes.

In another embodiment, there is provided a method further including determining a change in the ratios of distances of the markers within an axis of an array of tracking points, and further determining the orientation of the tracker by intra-axis resolution of the change in the ratios of the distances of the markers within the axis.

In an embodiment, there is provided an improved input device that is capable of tracking three-dimensional, six-degrees-of-freedom positions, coding the tracking result into digital data, and inputting it into a computer in real time. The input device has a tracker comprising at least one cluster which is an arrangement of one array of tracking points to define a first axis, a second array of tracking points to define a second axis or plane orthogonal to the first axis, with distances between the tracking points carefully selected such that a perspective, two-dimensional image of the tracking points captured by a camera can be used by a processor to determine the position and orientation of the input device in three-dimensional space using a provided algorithm.

In an embodiment, there are provided new types of complex markers that allow extracted local features of the markers to contribute to the accurate determination of their positions, while avoiding the shortcomings of the prior art.

In an embodiment, there is provided certain aspects of the Fun Wey '498 patent combined with the use of the abovementioned markers to provide a better single-camera optical tracking technology.

The complex markers of the present invention may include triangular or square shapes. These markers are different from the ‘Xpoint’ concept in that centers of these complex markers are within the enclosed area of the markers. The centers are not lying on the edges between contrasting regions. However, these complex markers have the similar advantage of ‘Xpoint’ concept in that the aspect of robustness in overcoming partial occlusion. If a marker is partially occluded such that some of the corners cannot be captured in the image, the boundary can still be completed via extrapolating the observed partial edges, which in turn leads to the determination of the marker's center.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIGS. 1a-1c illustrate exemplary complex marker types having straight edges;

FIG. 2 illustrates a tracker with two distinct ‘L’ clusters;

FIG. 3 illustrates a tracker composed of two ‘T’ clusters;

FIG. 4 illustrates a handheld probe with a single ‘T’ cluster of markers;

FIG. 5 illustrates a tracker with two ‘L’ clusters fixed with respect to one another, and lying on different planes with respect to one another; and

FIG. 6 illustrates a tracker having two ‘T’ clusters similar to the embodiment of FIG. 3, with a group of three closely positioned markers in place of a square marker.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

It is an object of the present invention to provide an input device for computer and gaming devices that accept 3D input. Such an input device is capable of providing nearly full-spherical, all-round tracking within its operating volume.

It is another object of the present invention to provide an input device for computer and gaming devices that allows the reproduction of intended 3D, 6 degrees-of-freedom (DOF) movements of virtual objects in the virtual environment. This type of movement input may be performed with minimal processor demands so that the present invention can be used in simpler, smaller or less expensive computers, and gaming devices, and not require too much processor resources from other concurrently-running processes.

The terms “computer” and “gaming devices” include, but are not limited to, any computing device that require 3D input such as CAD/CAM workstations, “personal computers”, dedicated computer gaming consoles and devices, personal digital assistants, and dedicated processors for processing images captured by the present invention.

In an embodiment, a tracker may include at last one cluster having a first array of tracking points to define a first axis, a second array of tracking points to define a second axis or plane orthogonal to the first axis, with the distances between the points carefully selected such that a perspective, perspective, two-dimensional image of the tracking points can be used to determine the position and orientation of the input device in three-dimensional space. Note that the tracking points may include more than one cluster, and in most cases the redundancy of having more clusters in a set of tracking points may improve the accuracy and robustness of the tracking. The only constraint is that the clusters within a tracker must be fixed relative to each other, such that their geometrical mapping remains constant.

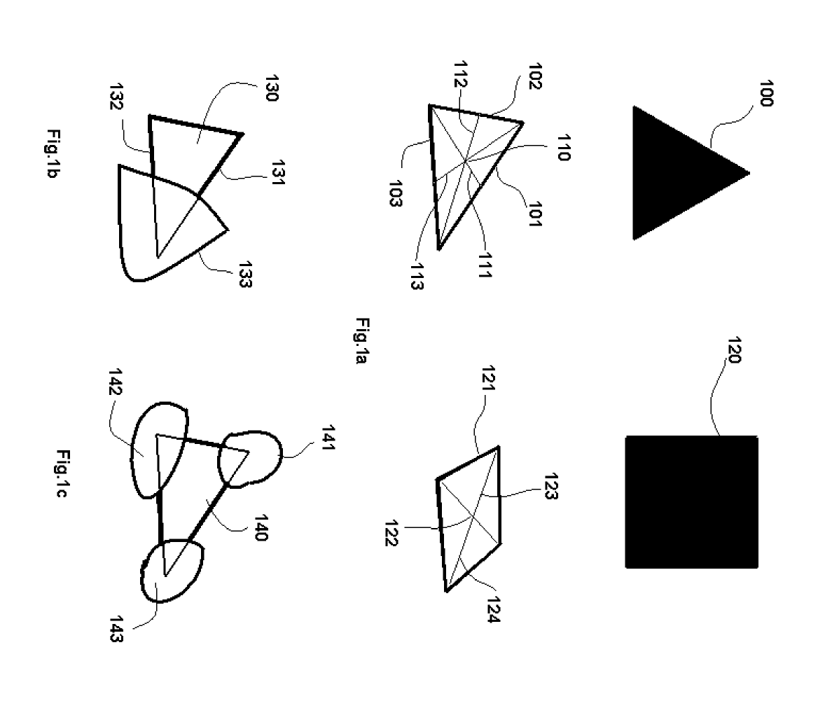

The ‘tracking points’, or markers, can be of simple type, such as spherical or circular shapes, or complex type, e.g., shapes composed of straight edges. The two simplest complex marker types 100 and 120 are as shown in FIG. 1a. Note that although the FIG. 1a shows the markers 100 and 120 as dark regions in a bright background, it could be the reverse where the markers are bright and the background is dark. The main aim is to attain a high-contrast image when captured by the camera.

In FIG. 1a, the marker 100 is of equilateral triangle shape. The external boundary of its perspective-projected image, as defined by the three edges 101, 102 and 103, can be extracted from using many sub-pixel edge detection algorithms. Some of these algorithms can be found in the published papers such as those of Avrahami, et al. and Zhen et al. Once the edges have been accurately extracted from the image, the center 110 of the marker in the image may be calculated from the closest point to the three intersections of the lines 111, 112 and 113. The lines 111, 112 and 113 are respectively those joining the mid points of the edges 101, 102 and 103 to the opposite corners of the projected triangle.

Another complex marker is that of square shape 120, illustrated in FIG. 1a. Likewise, the edges of its perspective-projected image 121 can be extracted using a sub-pixel edge detection algorithm, and the center 122 of the marker's image can be calculated from the intersection of the two diagonals 123 and 124.

The complex marker is able to remain detectable even with partial occlusion. In the case of when the image of the triangular marker 130 is partially occluded by an obstacle 133, as shown in FIG. 1b, such that the edges 131 and 132 appear as segments in the image. As long as the lengths of the segments are beyond certain predefined threshold, establishing credible edges, the algorithm extrapolates the edges to a meeting point, and, hence, completes the triangle. The determination of the marker's image's center may then be carried out as normal.

FIG. 1c shows a case where all the corners of a triangular marker 140 are occluded by obstacles 141, 142 and 143. In this case, the algorithm tentatively groups any three segments that are longer than certain threshold, and sufficiently proximal together, as triplets, and then extrapolates the segments until meeting so as to complete a triangle. The use of directional information related to the common bright area would also contribute to this process of marker image recognition.

For the triangular shaped marker 100, the extracted center of the marker's position in the 2D image may be slightly off-centered due to the perspective projection. For the rectangular shaped marker 120, the extracted center of the marker's position in the 2D image is perspective-invariant, and therefore it provides a better registration. Nonetheless, both types of markers can be used within a cluster to give it a unique identity.

In the Fun Wey '498 patent, the inclusion of an orientation marker for generating distinct images generated by two distinct poses could otherwise generate a similar image. The problems with using an orientation marker in certain circumstances have been mentioned herein. With the ability to precisely determine the centers of the markers, there is no longer the need for orientation marker.

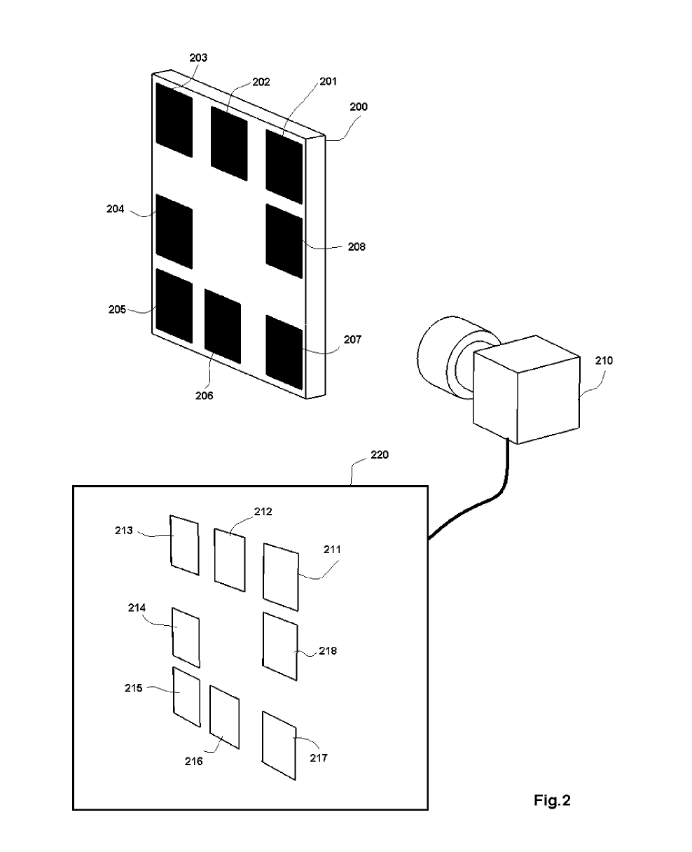

In FIG. 2, a tracker 200 with two distinct ‘L’ clusters is shown. The two ‘L’ clusters are distinguishable by the differences in spacing between the composing square markers. The first ‘L’ cluster has an axis defined by the markers 201, 202 and 203, and the other axis defined by the markers 201, 208 and 207. The second ‘L’ cluster has an axis defined by the markers 203, 204 and 205, and the other axis defined by markers 205, 206 and 207. The markers are positioned on the tracker such that the distances between the pairs of markers 201 and 202, between 201 and 208, between 205 and 204 and between 205 and 206 are all substantially different such that the algorithm is able distinguish between the pairs of markers, and, hence, the triplets and, eventually, the cluster where they belong to. Note that the distances between the adjacent corner markers (distance between markers 201 and 203, that between 201 and 207, that between 207 and 205, that between 203 and 205) are equal in the 3D space.

Selecting a suitable size of the marker depends on the need to distinguish the identity of the markers from their relative positions in the tracker. If there are more markers required on a tracker, then their size needs to be smaller so that there could be more distinct markers' pairs distinguishable by the spacing.

When the camera 210 captures the image of the tracker 200, it produces a perspective image 220 of the tracker, with the markers' images 211 to 218, respectively, corresponding to the markers 201 to 208 on the tracker. Once the edges of the markers' images are extracted and the centers determined, it could be found that the distance between the two further markers' images 213 and 215 is shorter than that between the two proximal markers' images 211 and 217. This is because the axis defined by the markers 203, 204 and 205 is further from the camera than that defined by markers 201, 208 and 207. Likewise the distance between the two further markers' images 217 and 215 is shorter than that between the two proximal markers' images 211 and 213. The change of the ratio between the spans of axes provides the information about the orientation of the tracker. This phenomenon is termed ‘inter-axis resolution’.

Besides the changes across different clusters on the tracker in the perspective image, it can also be observed that there are slight changes of the ratio of distances between markers' image within an axis. For example, the ratio of the distance between the markers' images 211 and 212 and that between the markers' images 212 and 213 is slightly increased from the ratio of that actual distance between the markers 201 and 202 and that between the markers 202 and 203. This is because the distance between the markers 202 and 203 is further from the camera and, thus, is projected to a smaller span on the image compared to the more proximal distance between the markers 202 and 201. Such slight change in ratio of distances within an axis also provides information about the orientation of the tracker. This phenomenon is termed ‘intra-axis resolution’.

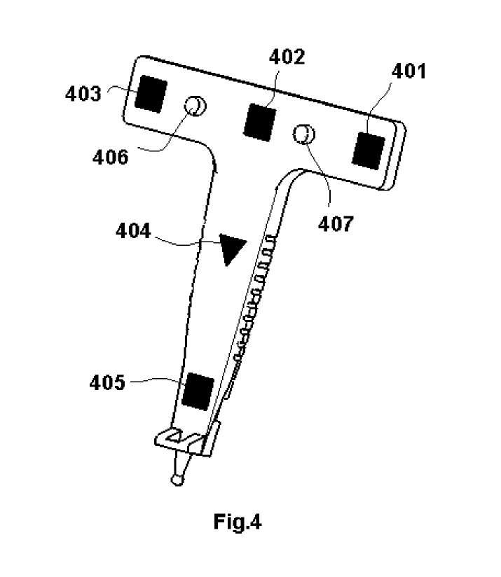

The combined use of both inter- and intra-axis methods may be exploited to improve the accuracy of the tracking. The inter-axis method allows better resolution of the pose as there would be greater change of lengths across different axes in the perspective-projected image. The intra-axis method can be used if there is space constraint on the tracker and that only a single cluster can be housed on it. An example of this case is the handheld probe 400 as shown in FIG. 4, where for easy handholding only a single ‘T’ cluster defined by the markers 401 to 405 is used due to the ergonomic design. It also has two markers 406 and 407 whose presence or absence reflects the states of the push buttons housed in the tracker.

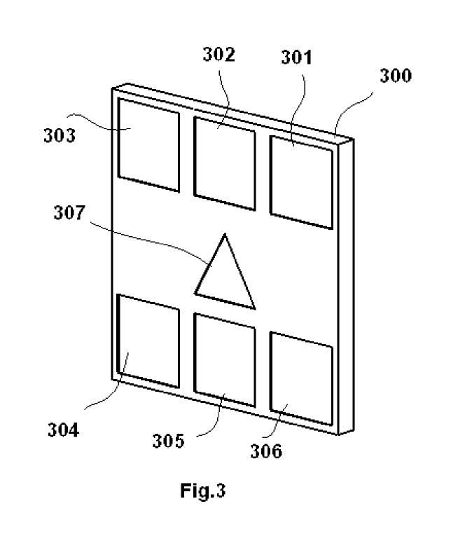

Similarly, a tracker composed of two ‘T’ clusters is as shown in FIG. 3. The two ‘T’ clusters are differentiable by the difference in the relative locations of the triangular marker 307 that is shared by them.

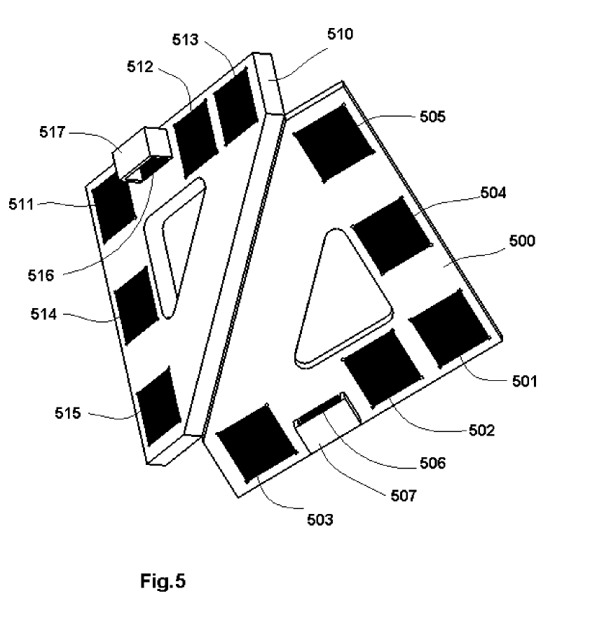

The inter-axis and intra-axis methods could also be combined with the use of orientation marker method. FIG. 5 shows a tracker with two ‘L’ clusters 500 and 510 that are fixed relative to each other but out-of-plane—i.e. they do not lie on the same 2D plane. Having such an arrangement has the advantage that the tracking remains effective over a larger span of orientation than having the two clusters on a single plane. The two clusters are differentiable by the relative positions of the markers 502 and 512 in the respective axes. Cluster 500 has an orientation marker 506 with shield 507 such that the marker 506 could be present or absent from the image depending on how the cluster 500 is oriented relative to the camera. Similarly cluster 510 has an orientation marker 516 with shield 517. Note that it is nearly impossible to accurately determine the pose of a single cluster from processing its image alone when the tracker is posed such that the shield is at a threshold of blocking the orientation marker. Of course, if the other cluster is still well within view of the camera, then this information can be used to resolve the ambiguity. If this is not the case then the last information that could help would be intra-axis method.

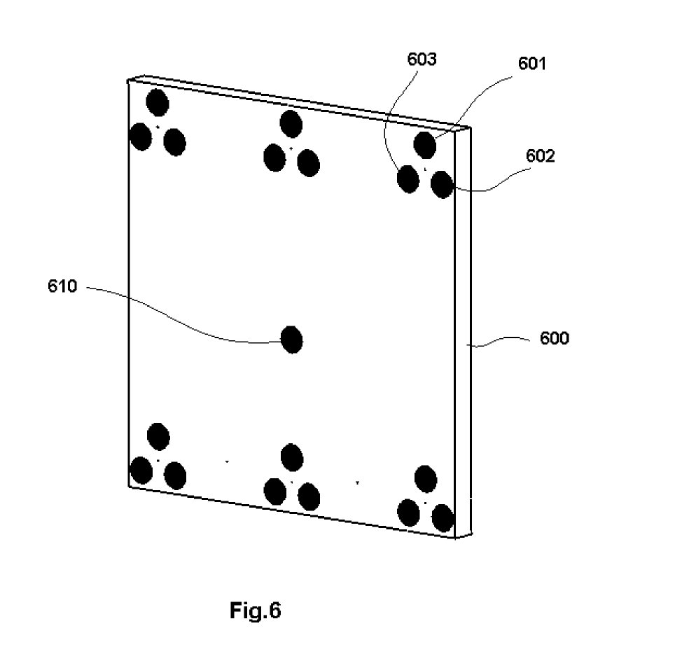

A complex marker can also be defined by a local grouping of simple markers that are relatively closely packed. FIG. 6 shows a tracker 600 including two ‘T’ clusters similar to tracker 300 shown in FIG. 3, except that each complex square marker of tracker 300 is replaced by a group of three simple markers that are relatively closely positioned. For example the complex marker 301 in tracker 300 is replaced by the group of simple markers 601, 602 and 603 that are arranged in a triangular formation on the tracker 600, and, whereas the central marker 307 is replaced by the simple marker 610. The relative distances between the markers are designed such that those markers defining a complex marker would be much closer than compared to the distances of markers defining distinct complex markers. The algorithm first sorts out the average distance between all simple markers on the image, and then those markers having distances to the two closest neighboring markers may be singled out and checked if the neighborhood relationships are mutual among each tentative group.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. An input device for providing three-dimensional, six-degrees-of-freedom data input to a computer, said device comprising:
a tracker having a plurality of tracking points, the tracker including:
a first array of the tracking points defining a first axis;
a second array of the tracking points defining one of a second axis and plane orthogonal to the first axis; and
at least one cluster of the tracking points of one of the first array and the second array;
selected distances between the tracking points disposed with respect to one another so as to allow a processor to determine position and orientation of the input device in three-dimensional space based on a perspective, two-dimensional image of the tracking points captured by at least one image-capturing device.

2. An input device in accordance with claim 1, wherein the each of the first array and the second array include at least one cluster of the tracking points.

3. An input device in accordance with claim 2, wherein the each of the first array and the second array include a plurality of clusters of the tracking points.

4. An input device in accordance with claim 1, wherein the plurality of tracking points include circular shapes.

5. An input device in accordance with claim 1, further comprising a marker having a shape formed by a plurality of straight edges, and wherein the plurality of the tracking points are formed by intersections of the straight edges of the marker.

6. An input device in accordance with claim 5, wherein the shape of the marker is a triangle.

7. An input device in accordance with claim 5, wherein the shape of the marker is a rectangle.

8. An input device in accordance with claim 5, wherein the shape of the marker is a polygon.

9. An input device in accordance with claim 1, wherein the plurality of tracking points and the tracker provide a high contrast to one another when captured by the at least one image-capturing device.

10. An input device in accordance with claim 1, wherein the first array and the second array form two distinct ‘L’ clusters of tracking points with respect to one another.

11. An input device in accordance with claim 1, wherein the first array and the second array form two distinct ‘T’ clusters of tracking points with respect to one another.

12. An input device in accordance with claim 1, wherein the at least one cluster of the tracking points forms a single ‘T’ cluster of tracking points.

13. An input device in accordance with claim 1, wherein the first array and the second array form two ‘L’ clusters fixed with respect to one another, and wherein the two ‘L’ clusters lay on different planes with respect to one another.

14. An input device in accordance with claim 1, wherein the first array and the second army form two distinct ‘T’ clusters of tracking points with respect to one another, and further including three closely positioned markers forming at least one of the plurality of tracking points.

15. A method of providing three-dimensional, six-degrees-of-freedom data input to a computer, the method comprising:
capturing a perspective, two-dimensional image of a plurality of tracking points of a tracker;
processing the perspective, two-dimensional image of the plurality of tracking points of the tracker to determine distances between the tracking points disposed with respect to one another; and
determining position and orientation of the input device in three-dimensional space using the distances determined between the tracking points in comparison to known distances between the tracking points disposed with respect to one another.

16. A method in accordance with claim 15, wherein the step of processing the perspective, two-dimensional image of the plurality of tracking points of the tracker to determine distances between the tracking points disposed with respect to one another includes extracting edges of a marker having a shape formed by a plurality of straight edges, and determining the plurality of the tracking points formed by intersections of the straight edges of the marker.

17. A method in accordance with claim 16, further including determining spans between centers of the markers of along two axes, including a first axis of a first array of the tracking points and a second axis of a second array of tracking points, and further determining the orientation of the tracker by inter-axis resolution of the spans of the axes.

18. A method in accordance with claim 16, further including determining a change in ratios of distances of the markers within an axis of an array of tracking points, and further determining the orientation of the tracker by intra-axis resolution of the change in the ratios of the distances of the markers within the axis.
